(19) United States
(12) Patent Application Publication
(10) Pub. No.: US 2004/0263432 A1
(43) Pub. Date: Dec. 30, 2004

(54) Plasma display panel

(75) Inventor: Masaki Yoshinari, Yamanashi-ken (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/868,877

(22) Filed: Jun. 17, 2004

(30) Foreign Application Priority Data
Jun. 25, 2003 (JP) 2003-180608

(51) Int. Cl. G09G 3/10; G09F 3/18

(52) U.S. Cl. 345/37

(57) ABSTRACT

A plasma display panel has front and back substrates facing each other to form a discharge space in between; a partition wall that is provided between the front and back substrates for partitioning the discharge space into discharge cells, and is formed of a metal base covered with an insulation layer; and an electromagnetic-wave blocking layer provided on a portion of the front substrate facing a non-display zone located around the image display zone so as to cover the portion facing the non-display zone.

### BACKGROUND OF THE INVENTION

1. Field of the Invention

This invention relates to the structure of plasma display panels.

The present application claims priority from Japanese Application No. 2003-180608, the disclosure of which is incorporated herein by reference.

2. Description of the Related Art

FIG. 1 is a side sectional view of a conventional display apparatus having a plasma display panel (hereinafter referred to as “PDP”).

In FIG. 1, the PDP 3 of the display apparatus is secured by an adhesive sheet 4 to the front-facing face (i.e. upward face in FIG. 1) of a chassis 2 mounted to the front of a rear casing 1.

A frame 5 is attached to the front-facing margin face of the chassis 2 so as to surround the PDP 3, and has an inner flange 5A provided on the front-facing end. A front filter (panel protective plate) 7 is mounted on the front-facing face of the inner flange 5A with the interposition of a gasket 6 and secured by a fitting 8.

FIG. 1 also shows a front casing 9 of the display apparatus.

FIG. 2 is a schematic side view illustrating the structure of the front filter (panel protective plate) 7 of the display apparatus.

In FIG. 2, the front filter (panel protective plate) 7 includes an electromagnetic-wave blocking layer (conductive mesh) 7B formed on a glass substrate 7A; an antireflective layer 7C formed on the electromagnetic-wave blocking layer 7B; and an infrared-radiation absorbing and color-tone correcting layer 7D formed on the back-facing face of the glass substrate 7A.

The structure of such a conventional PDP is described in Japanese unexamined patent publication No. 11-219122.

In the display apparatus, in consideration of the generation of electromagnetic waves due to a discharge produced in the discharge space of the PDP, the front filter (panel protective plate) 7 has an electromagnetic-wave blocking layer (conductive mesh) 7B laminated in order to prevent leakage of the electromagnetic waves from the PDP in the direction of the display surface of the display apparatus.

However, it is absolutely necessary for a display apparatus having the conventional PDP to have the front filter (panel protective plate) 7 include an electromagnetic-wave blocking layer for the blocking of the electromagnetic waves generated from the PDP. In addition, such a front filter (panel protective plate) 7 is very expensive. For these reasons, the display apparatus has the problem of an increase in product costs.

### SUMMARY OF THE INVENTION

The present invention is designed essentially to solve the problem associated with the conventional display apparatus as described above.

It is accordingly an object of the present invention to provide a plasma display panel capable of achieving reductions in production costs and in the weight of the panel.

To attain this object, the plasma display panel according to the present invention comprises a pair of front and back substrates facing each other to form a discharge space in between; a partition wall that is provided between the front and back substrates for partitioning the discharge space into discharge cells, and is formed of a metal base covered with an insulation layer; and an electromagnetic-wave blocking layer provided on and covering a portion of the front substrate facing a non-display zone located around an image display zone.

Accordingly, the electromagnetic waves generated by a discharge produced in the discharge space between the front and back substrates are absorbed in the panel display zone by the metal base forming part of the partition wall. The portion of the electromagnetic waves which would otherwise leak from the panel non-display zone (the area other than the display zone) in the direction of the display surface is absorbed by the electromagnetic-wave blocking layer situated on the portion of the front substrate facing the non-display zone.

With this plasma display panel, the provision of the electromagnetic-wave blocking layer only on the portion of the panel facing-the non-display zone offers a simplification of the structure of the front filter portion of a conventional plasma display. As a result, the achievement of reductions in production costs and in the weight of the panel is made possible.

These and other objects and features of the present invention will become more apparent from the following detailed description with reference to the accompanying drawings.

### BRIEF DESCRIPTION OF THE DRAWINGS

FIG. 1 is a side sectional view of the structure of a conventional display apparatus.

FIG. 2 is a side view illustrating the structure of a front filter of a conventional PDP.

FIG. 3 is a side sectional view illustrating a first embodiment of a PDP according to the present invention.

FIG. 4 is a front view illustrating the shape of an electromagnetic-wave blocking layer in the first embodiment.

FIG. 5 is a front view illustrating a partition wall in the first embodiment.

FIG. 6 is a sectional view taken along the W-W line in FIG. 5.

FIG. 7 is a side sectional view illustrating a second embodiment of a PDP according to the present invention.

FIG. 8 is a front view illustrating a partition wall in the second embodiment.

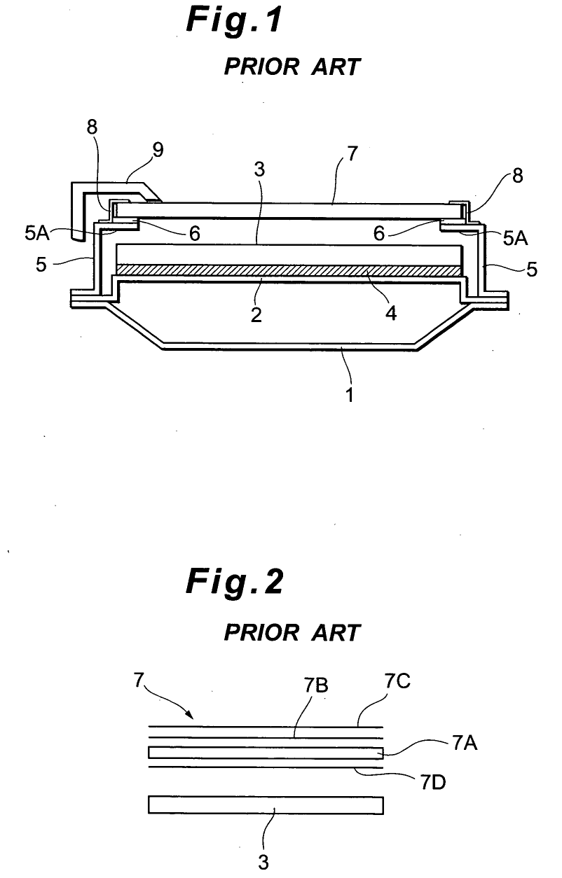

### DETAILED DESCRIPTION OF THE PREFERRED EMBODIMENTS

Preferred embodiments according to the present invention are described now in detail with reference to the accompanying drawings.

The present invention relating to a plasma display panel (hereinafter referred to as “PDP”) described in each of the following embodiments is applicable to any of various types of PDP, such as a reflection-type PDP in which a phosphor layer is provided on the back substrate and emits light by means of a discharge produced across a row electrode pair provided on the front substrate (a column electrode may be provided on either the front substrate or the back substrate), and a transmission-type PDP in which a phosphor layer is provided on the front substrate and emits light by means of a discharge produced across a row electrode pair provided on the back substrate (a column electrode may be provided on either the front substrate or the back substrate).

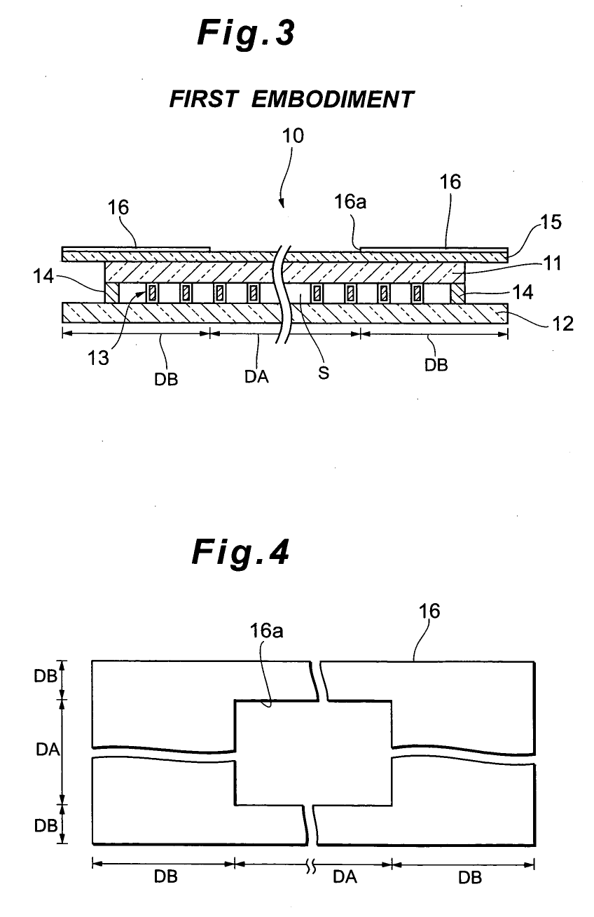

FIG. 3 is a side sectional view illustrating a first embodiment of the PDP according to the present invention.

In FIG. 3, the PDP 10 has a front glass substrate 11 forming the display surface of the panel and a back glass substrate 12 facing and parallel to the front glass substrate 11 at a predetermined interval. A discharge space S formed between the front glass substrate 11 and the back glass substrate 12 is partitioned in-to discharge cells by-a partition wall 13.

The discharge space S between the front glass substrate 11 and the back glass substrate 12 is sealed by a sealing layer 14.

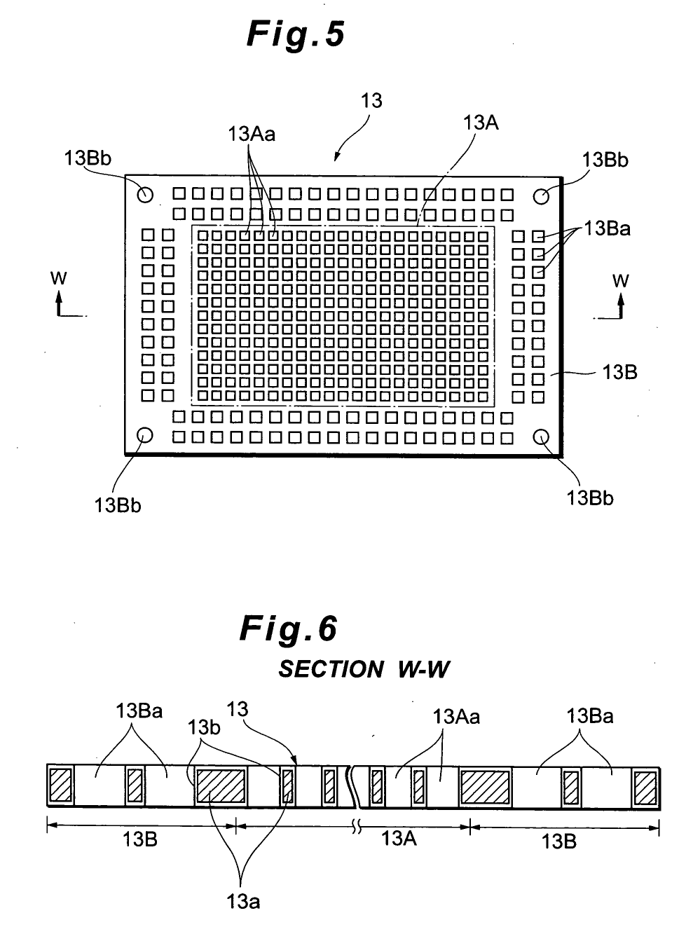

FIG. 5 is a front view illustrating the shape of the partition wall 13. FIG. 6 is a sectional view taken along the W-W line in FIG. 5.

In FIGS. 5 and 6, the partition wall 13 includes a metal base 13a and is formed in a plate shape. The metal base 13a has a portion 13A corresponding to the position of the display zone of the panel (hereinafter referred to as “display-zone portion”) Through holes 13Aa having a quadrangular opening are arranged in matrix form in the display-zone portion 13A. Around the display-zone portion 13A, there is a portion 13B corresponding to the position of the non-display zone of the panel (hereinafter referred to as “non-display-zone portion”). A plurality of dummy through holes 13Ba is formed in the non-display-zone portion 13B. The entire surface of this metal base 13a is covered with an insulation layer 13b to form the partition wall 13.

Reference numerals 13Bb in FIG. 5 indicate register through holes respectively provided in the non-display-zone-portion 13B at the four corners of the partition wall 13.

The metal-made partition wall 13 is laid on a dielectric layer (not shown) provided on the back glass substrate 12, and secured thereon after the through holes 13Aa and the corresponding discharge cells have been aligned.

Then, the metal-made partition wall 13 with the back glass substrate 12 attached are fired so that the two are secured together by means of the fusion between the insulation layer and the dielectric layer.

A front protective layer 15 is provided on the entire display surface of the front glass substrate 11.

The front protective layer 15 is formed of a lamination of an antireflective layer, an infrared-radiation absorbing layer, and a color-tone correcting layer, for example.

Further, an electromagnetic-wave blocking layer 16 is provided on a portion of the front-facing face of the front protective layer 15 corresponding to the non-display zone DB of the panel.

The electromagnetic-wave blocking layer 16 is formed of a metal mesh, a metal foil or the like, and has, as shown in FIG. 4, a quadrangular-shaped window 16a formed in the portion corresponding to the display zone DA of the panel.

In the PDP 10, electromagnetic waves, which are generated due to discharges produced between row electrodes and between the row electrode and the column electrode in the discharge space S, are absorbed in the display zone DA by the metal base 13a forming part of the partition wall 13, while the electromagnetic waves which would otherwise escape from the non-display zone DB (the area other than the display zone DA) in the direction of the display surface are absorbed by the electromagnetic-wave blocking layer 16 provided on the portion of the display surface of the front glass substrate 11 facing the non-display zone DB.

As described thus far, the PDP uses the metal-made partition wall 13 to absorb the electromagnetic waves generated in the display zone DA of the panel. Therefore, the provision of the electromagnetic-wave blocking layer 16 is required only in the portion facing the non-display zone DB of the panel, so that the structure of the front filter portion of a conventional PDP is simplified, resulting in reductions in production costs and in the weight in the panel.

In the first embodiment, the electromagnetic-wave blocking layer 16 is connected to a ground terminal of the chassis or the like of the PDP to set the electric potential of the electromagnetic-wave blocking layer 16 at GND for a further improvement in the effect of absorbing electromagnetic waves.

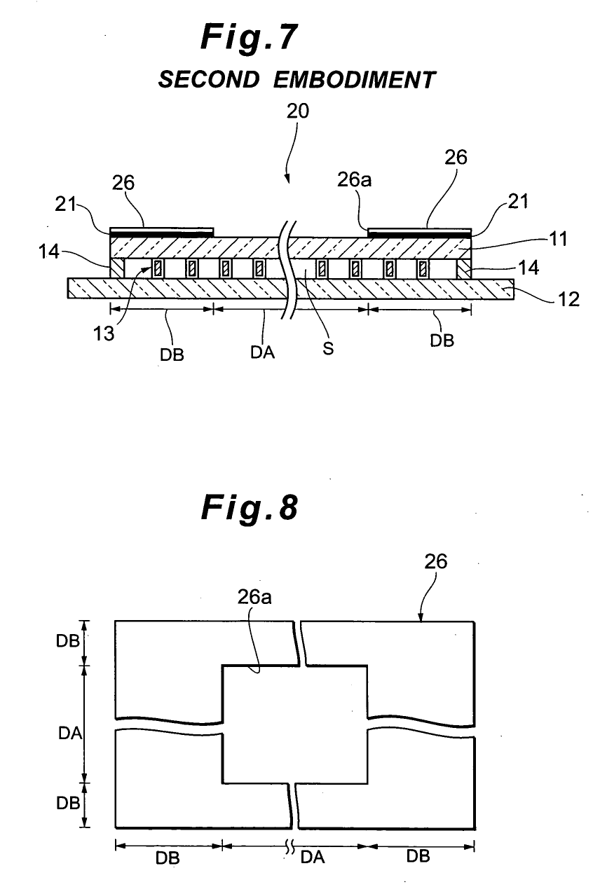

FIG. 7 is a side sectional view illustrating a second embodiment of a PDP according to the present invention.

In FIG. 7, the PDP 20 has a front glass substrate 11 forming the display surface of the panel and a back glass substrate 12 facing and parallel to the front glass substrate 11 at a predetermined interval. A discharge space S formed between the front glass substrate 11 and the back glass substrate 12 is partitioned into discharge cells by a partition wall 13 having the structure described in FIGS. 5 and 6.

The discharge space S between the front glass substrate 11 and the back glass substrate 12 is sealed by a sealing layer 14.

The above structure is substantially the same as that of the PDP in the first embodiment.

A black-or dark-colored light absorption layer 21 is provided on a portion of the front-facing face of the front glass substrate 11 facing the non-display-zone DB of the panel.

An electromagnetic-wave blocking layer 26 is further provided on the light absorption layer 21.

The electromagnetic-wave blocking layer 26 is formed of a metal mesh, a metal foil or the like, and has a quadrangular-shaped window 26a formed in the portion corresponding to the display zone DA of the panel as shown in FIG. 8.

In the PDP 20, electromagnetic waves, which are generated due to discharges produced between the row electrodes and between the row electrode and the column electrode in the discharge space S, are absorbed in the display zone DA by the metal base 13a forming part of the partition wall 13, while the electromagnetic waves which would otherwise escape from the non-display zone DB (the area other than the display zone DA) in the direction of the display surface are absorbed by the electromagnetic-wave blocking layer 26 provided on the portion of the display surface of the front glass substrate facing the non-display zone DB.

As described thus far, the PDP uses the metal-made partition wall 13 to absorb the electromagnetic waves generated in the display zone DA of the panel. Therefore, the provision of the electromagnetic-wave blocking layer 26 is required only in the portion opposite the non-display zone DB of the panel, so that the structure of the front filter portion of a conventional PDP is simplified, resulting in reductions in production costs and in the weight in the panel.

In the second embodiment, the electromagnetic-wave blocking layer 26 is connected to a ground terminal of the chassis or the like of the PDP to set the electric potential of the electromagnetic-wave blocking layer 26 at GND for a further improvement in the effect of absorbing electromagnetic waves.

The PDP described in each of the embodiments is based on a fundamental idea of a PDP comprising front and back substrates facing each other to form a discharge space in between; a partition wall that is provided between the front and back substrates for partitioning the discharge space into discharge cells, and is formed of a metal base covered with an insulation layer; and an electromagnetic-wave blocking layer provided on a portion of the front substrate facing a non-display zone located around an image display zone so as to cover the portion facing the non-display zone.

According to the fundamental idea, the electromagnetic waves generated by a discharge produced in the discharge space between the front and back substrates are absorbed in the display zone of the panel by the metal base forming part of the partition wall. The portion of the electromagnetic waves which would otherwise leak from the non-display zone of the panel (the area other than the display zone) in the direction of the display surface is absorbed by the electromagnetic-wave blocking layer situated on the portion of the front substrate facing the non-display zone.

With this plasma display panel, the provision of the electromagnetic-wave blocking layer only on the portion of the panel facing the non-display zone offers a simplification of the structure of the front filter portion of a conventional plasma display. As a result, the achievement of reductions in production costs and in the weight of the panel is made possible.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel, comprising:
a pair of front and back substrates facing each other to form a discharge space in between;
a partition wall provided between the front and back substrates for partitioning the discharge space into discharge cells, and formed of a metal base covered with an insulation layer; and
an electromagnetic-wave blocking layer provided on and covering a portion of the front substrate facing a non-display zone located around an image display zone.

2. A plasma display panel according to claim 1, wherein the electromagnetic-wave blocking layer is formed of a metal mesh.

3. A plasma display panel according to claim 1, wherein the electromagnetic-wave blocking layer is formed of a metal foil.

4. A plasma display panel according to claim 1, wherein the electromagnetic-wave blocking layer is provided on a display-surface-facing face of the front substrate.

5. A plasma display panel according to claim 4, further comprising a protective layer provided on the display-surface-facing face of the front substrate, wherein the electromagnetic-wave blocking layer is provided on the protective layer.

6. A plasma display panel according to claim 4, further comprising either a black-colored or a dark-colored light absorption layer provided between the front substrate and the electromagnetic-wave blocking layer.

7. A plasma display panel according to claim 1, wherein the electromagnetic-wave blocking layer is connected to a ground terminal.
